(19) United States
(12) Patent Application Publication
(10) Pub. No.: US 2015/0317649 A1
(43) Pub. Date: Nov. 5, 2015

(54) METHOD AND APPARATUS FOR PROVIDING PASSPHRASE ENABLED POINT OF INTEREST

(71) Applicant: NOKIA CORPORATION, Espoo (FI)

(72) Inventors: Dhaval JOSHI, Bangalore (IN); Pankaj NATHANI, Gujarat (IN)

(21) Appl. No.: 14/651,604

(22) PCT Filed: Oct. 30, 2013
(86) PCT No.: PCT/FI2013/051025

§ 371 Date: Jun. 11, 2015

(30) Foreign Application Priority Data
Dec. 17, 2012 (IN) 5275/CHE/2012

(51) Int. Cl. G06Q 30/02

(52) U.S. Cl. CPC G06Q 30/0203

(57) ABSTRACT

An approach is provided for determining a request from a user to access data associated with at least one point of interest (501). Then, the point of interest platform causes a presentation of at least one prompt for the user to provide information related to one or more brands associated with the at least one point of interest (503). Subsequently, the point of interest platform causes, at least in part, a presentation of at least a portion of the data and/or additional data based, at least in part, on the information provided by the user (505).

### BACKGROUND

Service providers and device manufacturers (e.g., wireless, cellular, etc.) are continually challenged to deliver value and convenience to consumers by, for example, providing compelling network services. One area of development has been in mapping and navigation services that aid users in finding points of interest (POIs), for instance, by displaying brands associated with POIs as visual guidance information to users. Such brands may have additional information which may be attractive to the users, and with which they may want to be associated. The service providers may present passphrase enabled POIs, wherein the users may be prompted with brand related queries to access additional information. Unfortunately, there is currently no convenient means of providing passphrase enabled POIs during mapping and navigation services. Accordingly, service providers and device manufacturers face significant technical challenges in providing passphrase enabled POIs for creating, disseminating, retaining, measuring and monitoring brand awareness during mapping and navigation services.

### SOME EXAMPLE EMBODIMENTS

Therefore, there is a need for an approach for providing passphrase enabled POIs, by causing a presentation of at least a portion of the data, additional data, or a combination thereof for one or more brands associated with the at least one POI based, at least in part, on the information provided by the user.

According to one embodiment, a method comprises determining a request from a user to access data associated with at least one point of interest. The method also comprises causing, at least in part, a presentation of at least one prompt for the user to provide information related to one or more brands associated with the at least one point of interest. The method further comprises causing, at least in part, a presentation of at least a portion of the data, additional data, or a combination thereof based, at least in part, on the information provided by the user.

According to another embodiment, an apparatus comprises at least one processor, and at least one memory including computer program code for one or more computer programs, the at least one memory and the computer program code configured to, with the at least one processor, cause, at least in part, the apparatus to determining a request from a user to access data associated with at least one point of interest. The apparatus is also caused to causing, at least in part, a presentation of at least one prompt for the user to provide information related to one or more brands associated with the at least one point of interest. The apparatus is further caused to causing, at least in part, a presentation of at least a portion of the data, additional data, or a combination thereof based, at least in part, on the information provided by the user.

According to another embodiment, a computer-readable storage medium carries one or more sequences of one or more instructions which, when executed by one or more processors, cause, at least in part, an apparatus to determining a request from a user to access data associated with at least one point of interest. The apparatus is also caused causing, at least in part, a presentation of at least one prompt for the user to provide information related to one or more brands associated with the at least one point of interest. The apparatus is further caused to causing, at least in part, a presentation of at least a portion of the data, additional data, or a combination thereof based, at least in part, on the information provided by the user.

According to another embodiment, an apparatus comprises means for determining a request from a user to access data associated with at least one point of interest. The apparatus also comprises means for causing, at least in part, a presentation of at least one prompt for the user to provide information related to one or more brands associated with the at least one point of interest. The apparatus further comprises means for causing, at least in part, a presentation of at least a portion of the data, additional data, or a combination thereof based, at least in part, on the information provided by the user.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of causing a presentation of at least a portion of the data, additional data, or a combination thereof for one or more brands associated with the at least one POI based, at least in part, on the information provided by the user, according to one embodiment;

FIG. 2 is a diagram of the components of the point of interest platform 109, according to one embodiment;

FIG. 3 is a diagram of the components of the attribute analysis module 203, according to one embodiment;

FIG. 4 is a diagram of geographic database 111 of system 100, according to exemplary embodiments;

FIG. 5 is a flowchart of a process for causing a presentation of at least a portion of the data, additional data, or a combination thereof for one or more brands associated with the at least one POI based, at least in part, on the information provided by the user, according to one embodiment;

FIG. 6 is a flowchart of a process for causing a processing of the information provided by the user to cause, a generation of one or more awareness reports with respect to the one or more brands and/or the at least one POI, according to one embodiment;

FIG. 7 is a flowchart of a process for causing a presentation of a representation of the at least one POI in a user interface if the user provides the information related to the one or more brands, according to one embodiment;

FIG. 8 is a diagram of user interface utilized in the processes of FIGS. 5-7, according to various embodiments;

FIG. 9 is a diagram of user interface utilized in the processes of FIGS. 5-7, according to various embodiments;

FIG. 10 is a diagram of user interface utilized in the processes of FIGS. 5-7, according to various embodiments;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for causing a presentation of at least a portion of the data, additional data, or a combination thereof for one or more brands associated with the at least one POI based, at least in part, on the information provided by the user are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

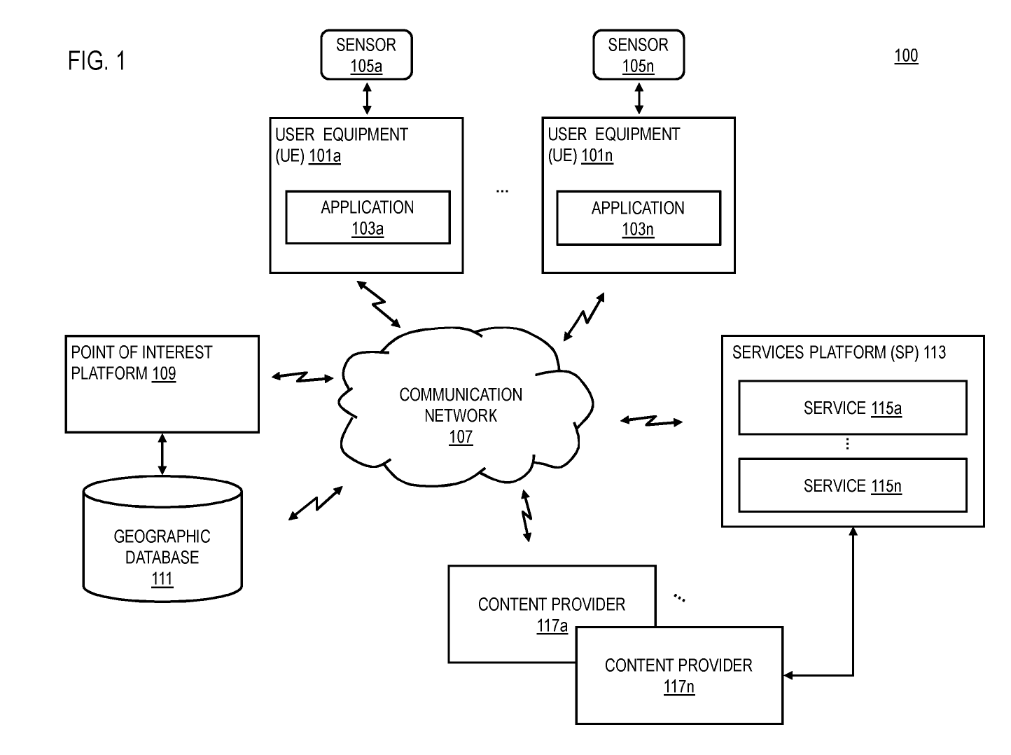

FIG. 1 is a diagram of a system capable of causing a presentation of at least a portion of the data, additional data, or a combination thereof for one or more brands associated with the at least one POI based, at least in part, on the information provided by the user. As discussed previously, one big challenge with the use of maps during navigation or exploration is that there is currently no convenient means of enabling POIs to create, disseminate, retain, measure and monitor their brands. This is due, in part, to the inability of the device or services of the device to accurately determine the one or more means to oversee the brands associated with POIs the user interacts with. Though map based navigation services are becoming popular, they lack mass market adoption. In addition, huge number of population does not have required devices or awareness to use such services. Since mobile phones have so far emerged as the most personalized and the most reachable communication device, business owners may want to promote their brands by using POIs, and enhance public relations. POIs are very generic in nature, but in recent years, need for leveraging POIs to differentiate user value has come in focus. Unfortunately, device application and/or service providers have no convenient means of promoting brands through POIs. As a result, providers of applications and services for device users are limited in their ability to customize features and services they offer based on the query enabled POIs for creating, retaining and measuring brand awareness.

To address this problem, a system 100 of FIG. 1 introduces the capability to present passphrase enabled POIs for causing a presentation of at least a portion of the data, additional data, or a combination thereof for one or more brands associated with the at least one POI based, at least in part, on the information provided by the user. By way of example, the attributes determined to be associated with a brand may be used to generate one or more queries, including, one or more passphrases, one or more jingle lyrics, one or more audio samples, one or more colors, one or more shapes, one or more images, one or more names or a combination thereof. In one scenario, XYZ shop, a clothing brand may choose to promote its brand using POIs. Hence, when a user explores a certain category (e.g., fashion apparel) on map based service, a number of POIs are plotted on the map which may include XYZ shop. The POI for xyz shop may be protected, and the user may be required to answer queries which may be associated with various attributes of the brand. Upon opening the POI, the user may access basic information which is freely available. However, the user must enter the correct passphrase to the queries to access exciting offers that users otherwise would have no access to, such as, special deals, coupons, discounts etc. A passphrase can be any information provided by a user to unlock the POI.

In one embodiment, POIs may be determined based on user interaction coupled with location information (e.g., proximity information, historical user information, predicted user information, contextual information, location-based content information etc.) associated with UE 101. Then, the point of interest platform 109 may determine a request from a user to access data associated with at least one POI by causing, at least in part, a presentation of at least one prompt for the user to provide information related to one or more brands associated with the at least one POI. Subsequently, the point of interest platform 109 causes, at least in part, a presentation of at least a portion of the data, additional data, or a combination thereof based, at least in part, on the information provided by the user.

As mentioned, one big challenge with the use of maps during navigation or exploration is that the maps do not have query enabled POIs for creating, retaining and measuring brand awareness. For example, each POIs are typically identified by name (e.g., XYZ shop) or street number (e.g., 1234 Main Street) or brand logo. The system 100 attempts to better utilize the brand identification for POIs, by allowing users to associate with brand information for the determined POIs as a means of creating brand awareness and, thus, providing an approach for easy and speedy marketing tactics. In one scenario, for instance, a user may want to visit XYZ shop. As such, the user may use his mobile phone to access navigation services while driving to XYZ shop. In this example, XYZ shop has some kind of visual identity (e.g., brand logo). In various embodiments, the system 100 (e.g., via a point of interest platform 109) may process the location information and/or content information for the determined POI (i.e. XYZ shop). The processed information is then utilized in creating queries for the determined POI. Such queries may be passphrases, one or more jingle lyrics, one or more audio samples, one or more colors, one or more shapes, one or more images, one or more names or a combination thereof. In this way, a navigation service may present the user with at least one prompt to provide information related to the brand associated with XYZ shop. Subsequently, the user may be provided with additional information, such as, value offer information upon entering the correct information to the query.

As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UEs 101 have connectivity to a point of interest platform 109 via the communication network 107. In one embodiment, the point of interest platform 109 performs one or more functions associated with enabling POIs with queries for creating, retaining and measuring brand awareness. Such queries may be answered by the user upon receiving a prompt to provide information related to one or more brands associated with the at least one point of interest. Such prompt may be presented in association with the UE 101, for instance, in conjunction with the applications 103 and/or related services 115a-115n of the services platform 113. By way of example, the applications 103 may be any type of application that is executable at the UE 101, such as mapping applications, navigation applications, and/or any other applications that may use POI information including general applications such as media player applications, social networking applications, calendar applications, content provisioning services, and the like. As another example, when the application 103 is a mapping application, it can generate routes, travel destinations or maps based on user inputs. Under this scenario, in addition to generating a traditional route based on the shortest distance, fastest travel time, scenic route, etc., the mapping application may present various route selections that feature POIs information based on the brand. It is noted, in this example, that the profile information enables the mapping application to influence locations and geo-routines by selecting those locations and geo-routines which are found to have attributes aligned with the user. In one embodiment, one of the applications 103 at the UE 101 may act as a client for point of interest platform 109 and perform one or more functions associated with the functions of the point of interest platform 109. In addition, the sensors 105 may be any type of sensor. In certain embodiments, the sensors 105 may include, for example, a camera/imaging sensor for gathering image data, an audio recorder for gathering audio data, a global positioning sensor for gathering location data, a position sensor or gyroscope for detecting device orientation and/or tilt, a network detection sensor for detecting wireless signals or network data, temporal information and the like. This information is provided to the point of interest platform 109 for processing to determine contextual information associated with UE 101. In certain embodiments, the contextual information may be used in connection with information regarding brands associated with POIs.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the point of interest platform 109 may include or have access to a geographic database 111 to access or store any kind of data associated with POI, such as historical user information, location proximity information, temporal proximity information, contextual proximity information, etc. Data stored in the geographic database 111 may, for instance, be provided by the UEs 101, a service platform 113, one or more services 115a-115n (or services 115), or one or more content providers 117a-117n (or content providers 117). In one embodiment, the geographic database 111 may include an index of various brands, one or more attributes associated with said brands. The index is able to be queried by the point of interest platform 109 based on a provided input, such as, from interacting with application 103 via the UE 101. The one or more attributes associated with the brand is then maintained by the index.

In one embodiment, the point of interest platform 109 may be a platform with multiple interconnected components. The point of interest platform 109 may include multiple servers, intelligent networking devices, computing devices, components and corresponding software for performing the function of providing query enabled POIs for creating, retaining and measuring brand awareness. In addition, it is noted that the point of interest platform 109 may be a separate entity of the system 100, a part of the one or more services 115 of the service platform 113, or included within the UE 101 (e.g., as part of the application 103). In one embodiment, the point of interest platform 109 may perform one or more of the following: (a) determines brands based on a request from a user to access POIs which is further based on contextual data, as collected by applications 103, sensors 105, services 115 and contents 117; (b) facilitates the association of brand information determined to be affiliated with the brand; (c) facilitate the continual retrieval of brand information from applications 103, sensors 105, services 115 and contents 117; (d) facilitate the continual updating, ranking, prioritizing and organizing of the one or more brand information on a periodic or on demand basis for ensuring consistent relevancy of the brand information.

In one embodiment, the point of interest platform 109 may cause, at least in part, a presentation of at least one prompt for the user to provide information related to one or more brands associated with the at least one point of interest, upon determining a request from a user to access data associated with at least one point of interest. Then, the point of interest platform 109 may cause at least in part, a presentation of at least a portion of the data and/or additional data based, at least in part, on the information provided by the user. As indicated in the above scenario, a user may want to visit XYZ shop. When the user opens the navigation application, his location is known to the server. The user then enters any known information for the POI in his mobile communication device (e.g., UE 101), the mobile communication device then sends a request to the point of interest platform 109 for generation of navigation information. The point of interest platform 109 then communicates with the geographic database 111, the services platform 113 and the content provider 117 for relevant brand information. Upon presentation of the brand with POI, the point of interest platform 109 may determine a request to access data associated with POI based on user interaction. Then, the point of interest platform 109 may prompt the user to provide information related to the brand associated with the XYZ shop. Such prompt may include, at least in part, one or more hints. Once the user provides the required brand information, the point of interest platform 109 causes, at least in part, a presentation of one or more value offer information which may comprise of special deals, discounts, coupons, etc. Such presentation of additional information is further based on one or more expiration parameters, one or more temporal parameters, one or more location parameters, or a combination thereof. On the other hand, the point of interest platform 109 causes restriction of access to the at least a portion of the data, the additional data, or a combination thereof by the user if the user does not provide the information related to the one or more brands.

In one scenario, the point of interest platform 109 may verify the information provided by the request sending UE 101, as a response to the query. In one embodiment, the point of interest platform 109 may cause, at least in part, a comparison of the information provided by the user against reference information stored for the at least one POI, wherein the presentation of the at least a portion of the data, the additional data, or a combination thereof is based, at least in part, on the comparison. Further, the reference information is distributed through one or more social networks, one or more broadcast media, one or more print media, or a combination thereof.

As mentioned before, the point of interest platform 109 facilitates the continual updating, ranking, prioritizing and organizing of the one or more brand information on a periodic or on demand basis for ensuring consistent relevancy of the brand information. In one embodiment, the point of interest platform 109 may process and/or facilitate a processing of the information provided by the user to cause, at least in part, a generation of one or more awareness reports with respect to the one or more brands and/or POIs. In addition, the point of interest platform 109 may continuously, periodically, according to a schedule, on demand, or a combination thereof monitor brand awareness; and cause, at least in part, an updating of the one or more awareness reports, based, at least in part, on the monitoring.

The services platform 113 may include any type of service. By way of example, the services platform 113 may include mapping services, navigation services, social networking services, content (e.g., text, images, etc.) provisioning services, application services, storage services, contextual information determination services, location based services, information (e.g., weather, news, etc.) based services, etc. In one embodiment, the services platform 113 may interact with the UE 101, the point of interest platform 109 and the content providers 117 to supplement or aid in the processing of the content information.

By way of example, services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability. The services 115 may additionally assist in providing the point of interest platform 109 with occurrence information of the one or more brand information for POIs.

The content providers 117 may provide content to the UE 101, the point of interest platform 109, and the services 115 of the services platform 113. The content provided may be any type of content, such as textual content, image content, etc. In one embodiment, the content providers 117 may provide content that may supplement content of the applications 103, the sensors 105, or a combination thereof. By way of example, the content providers 117 may provide content that may aid in the processing of the content information associated with POIs to determine brand information associated with POIs. In one embodiment, the content providers 117 may also store content associated with the UE 101, the point of interest platform 109, and the services 115 of the services platform 113. In one embodiment, the content providers 117 may manage access to a central repository of data, and offer a consistent, standard interface to data, such as a repository of users' navigational data content. In another embodiment, the content providers 117 act as hosts of one or more websites, social networking services, blogs, advertising materials, review information, data feeds, or sources of other information and/or documents. By way of example, the information and/or published documents provided by the content providers 117 may feature the name, symbol, image or sound associated with a brand. The content providers 117 are designated as sources of information regarding the various attributes of a brand by the manufacturer of the brand.

By way of example, the UE 101, the point of interest platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

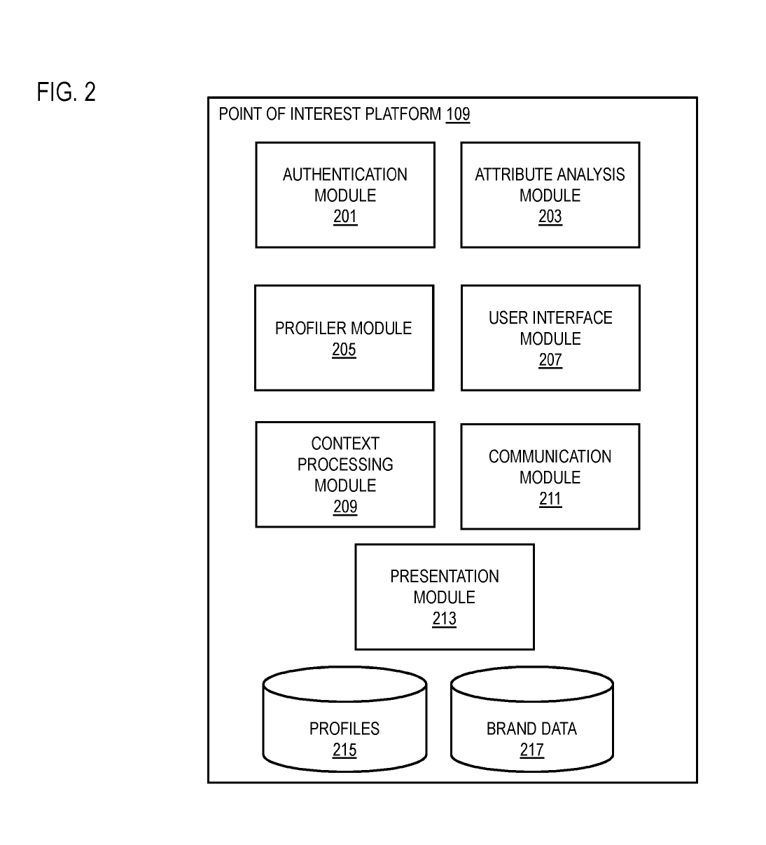

FIG. 2 is a diagram of the components of a point of interest platform 109, according to one embodiment. By way of example, the point of interest platform 109 includes one or more components for providing passphrase enabled POIs, by causing a presentation of at least a portion of the data, additional data, or a combination thereof for one or more brands associated with the at least one POI based, at least in part, on the information provided by the user, according to one embodiment. It is contemplated that the functions of these components may be combined in one or more components or performed by other components of equivalent functionality. In this embodiment, the point of interest platform 109 includes an authentication module 201, attribute analysis module 203, profiler module 205, user interface module 207, context processing module 209, communication module 211, and presentation module 213. In addition, the various modules of the platform 103 accesses one or more databases for enabling execution of its various functions. These databases include a profile 215 for accessing profiling information pertaining to a user of UE 101 and a brand database 217 for maintaining an index of the various brands and their attributes.

In one embodiment, an authentication module 201 authenticates users and UE 101 for interaction with the point of interest platform 109. By way of example, the authentication module 201 receives a request to subscribe to the point of interest platform 109 for enabling generation of route images with brands in connection with a selected POI. The subscription process may include, for example, establishing one or more services the user is affiliated with as well as their respective access credential information. Subscription may also entail selection of an “opt-in” option, wherein users of the point of interest platform 109 permits sharing of their context information (e.g., location information, position information and temporal information) as collected via one or more sensors 105 of UE 101 and/or geographic database 111 and/or services 113. Preferences and settings information may be referenced to a specific user, user device, or combination thereof and maintained in the geographic database 111. It is further noted, in certain embodiments, that the subscription process may be coordinated with a subscription process of a given services 115 accessed by a user.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the point of interest platform 109 (e.g., as enabled by user interface module 207). Profile data pursuant to registration may be cross referenced as part of the login process. Alternatively, the login process may be performed through automated association of profile settings maintained with an IP address, a carrier detection signal of a user device, mobile directory number (MDN), subscriber identity module (SIM) (e.g., of a SIM card), radio frequency identifier (RFID) tag or other identifier.

The authentication module 201 may also be alerted of an input received via the user interface for indicating a user requested action. It is noted that the user interface module 207 supports presentment of the user interface element for presenting such images while the authentication module 201 interprets input provided to the user as they engage the point of interest platform 109. The authentication module 201 is therefore configured to receive requests for generation of a map image via the service or application.

In one embodiment, the attribute analysis module 203 retrieves attributes from content providers 117. By way of example, the attribute analysis module 203 supports the updating and/or generation of the index maintained as brand database 217 with various ranked attribute terms related to a brand. As noted previously, the content providers 117 provide access to one or more advertising materials, blog data, social network data, data feeds, reviews, video and audio data, etc., and other information; all of which pertain in whole or part to a particular brand. The attribute analysis module 203 searches for and/or retrieves said information periodically or on demand (e.g., in response to a brand identification request). Once retrieved, the attribute analysis module 203 ranks the information by various criteria, according to one embodiment. By way of example, the ranking may be based on the total number of occurrences of a specific attribute for a brand, the date of the information, etc. The attributes having the highest ranking and/or weights may be considered for creating a query for brands.

In one embodiment, the profiler module 205 processes the one or more attributes for the determined brands, to determine profile information associated with the at least one user, the at least one device, or a combination thereof. This is done, for example, in response to a request by a calling application and/or service. By way of example, the profiler module 205 cross-references the point of interest platform 109 to determine if at least one of the terms matches that indicated in a user profile. Further, the profiler module 205 may operate in connection with the authentication module 201 to enable updating of the profile information to include a reference to one or more brands having correlated attribute terms. As such, an application, service, or other executable process of the UE may reference the one or more brands for carrying out various tasks.

In one embodiment, the user interface module 207 enables presentment of brand information while presenting map images in connection with a selected POI. By way of example, the user interface module 207 generates the user interface element in response to detection of an input for selection of POI in a map. As another example, the user interface module 207 enables representation of POI with determined brands presented via the user interface. Of note, the user interface module 207 triggers execution of the various other modules, including the authentication module 201 in response to user input. The user interface module 207 employs various application programming interfaces (APIs) or other function calls corresponding to the application 103 of UE 101; thus enabling the display of graphics primitives such as menus, buttons, data entry fields, etc., for generating the user interface elements. By way of example, the user interface module 207 generates the interface in response to application programming interfaces (APIs) or other function calls corresponding to the browser application or web portal application of the user devices 101a-101n; thus enabling the display of graphics primitives.

In one embodiment, the context processing module 209 receives context information as gathered by the sensors 105 of respective UE 101 and/or geographic database 111 and/or services 115. Once received, the context processing module 209 analyzes the context information to determine the relative location, time, position and other information useful for generating a map in association with a specified location. Based on this determination, the context processing module 209 triggers execution of the communication module 211.

In one embodiment, a communication module 211 enables formation of a session over a communication network 107 between the point of interest platform 109 and the services 115. By way of example, the communication module 211 executes various protocols and data sharing techniques for enabling collaborative execution between a subscriber's UE 101 and the point of interest platform 109 over the communication network 107.

The presentation module 213 makes a presentation of the map with determined brands highlighted therein for POI upon receiving the data from communication module 211. The presentation module 213 may utilize the geographic database and/or services 115 to determine whether the information for POI is up to date. This module obtains a set of summary statistics from other modules. Then, the module continues with generating a presentation corresponding to the POI. Then, continues with providing of presentation data set where the presentation could be depicted in one or more visual display units.

The above presented modules and components of the point of interest platform 109 can be implemented in hardware, firmware, software, or a combination thereof Though depicted as a separate entity in FIG. 1, it is contemplated that the point of interest platform 109 may be implemented for direct operation by respective UE 101. As such, the point of interest platform 109 may generate direct signal inputs by way of the operating system of the UE 101 for interacting with the application 103. In another embodiment, one or more of the modules 201-213 may be implemented for operation by respective UEs, as a point of interest platform 109, or combination thereof. Still further, the point of interest platform 109 may be integrated for direct operation with services 115, such as in the form of a widget or applet, in accordance with an information and/or subscriber sharing arrangement. The various executions presented herein contemplate any and all arrangements and models.

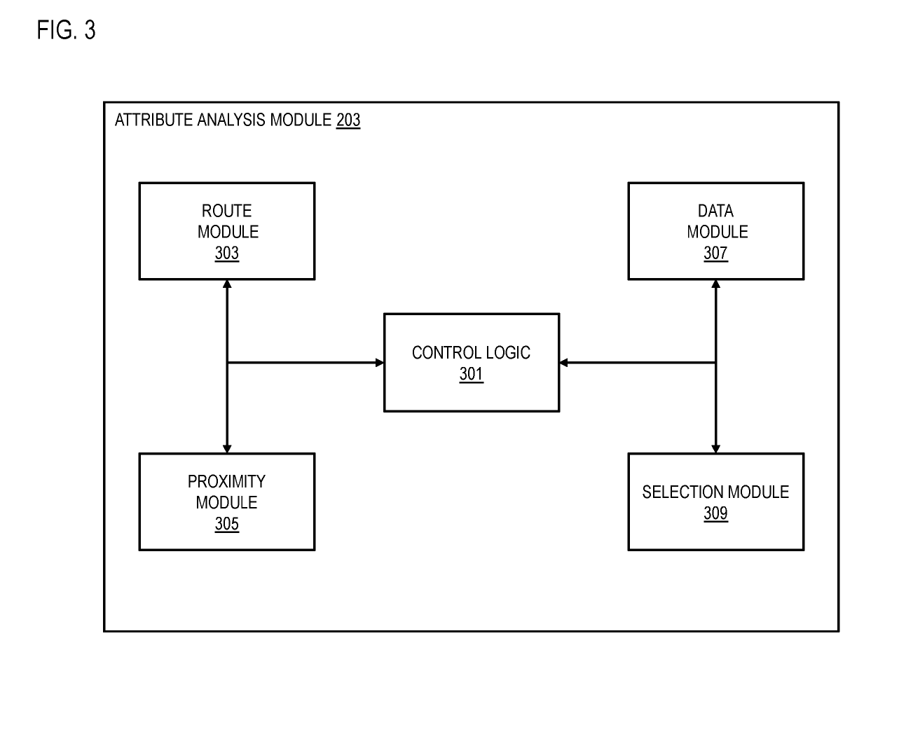

FIG. 3 is a diagram of the components of the attribute analysis module 203, according to one embodiment. By way of example, the attribute analysis module 203 includes one or more components for causing an update and/or generation of index with various attributes related to a brand. It is contemplated that the functions of these components may be combined in one or more components or performed by other components of equivalent functionality. In this embodiment, the attribute analysis module 203 includes a control logic 301, route module 303, proximity module 305, data module 307 and selection module 309.

The control logic 301 executes at least one algorithm for executing functions at the presentation module 213. For example, the control logic 301 may interact with the route module 303 to receive one or more geo-routes associated with one or more UEs 101. In one embodiment, the route module 303 may determine one or more geo-routes using historical and/or predicted user information, such as the daily work commute traveled by one or more UEs 101. With the one or more geo-routes, the control logic 301 and the proximity module 305 may determine proximity information of one or more UEs 101 to one or more POI. The control logic 301 and the proximity module 305 may determine proximity information that includes, at least in part, location, temporal, contextual proximity information, or a combination thereof.

The control logic 301 and data module 307 may define POI information, while the selection module 309 may select the determined POI based, at least in part, on the proximity information determined by the proximity module 305. For instance, the selected

POI with one or more geo-routes and/or one or more location anchors within a certain proximity threshold of one or more UEs 101 may be chosen out of all the other POI. Alternately, the control logic 301 and selection module 309 may sort the one or more POI based on proximity information. For example in one scenario, the control logic 301 and selection module 309 may determine to select top ten POI that is geographically closest to a UE 101.

In one embodiment, the selection module 309 may select the one or more POI based, at least in part, on the location information. For instance, one or more POI information may be selected because the history of geo-routes indicates that they will soon be proximate location (e.g., regardless of whether the UEs 101 are already in the location, as the predicted user information suggests that UEs 101 may soon be within the vicinity). Further, the selection module 309 may determine one or more predicted locations of a user based, at least in part, on the ease of access from a location associated with the UEs 101.

Further the selection module 309 may interact with other modules of point of interest platform 109 to direct the one or more UEs 101 to the chosen POI. For example, the control logic 301 and application 103 may work together to determine navigation guidance information to cause, at least in part, a presentation of the one or more POI. In one scenario, this may include UEs 101 displaying directions on how to reach POI.

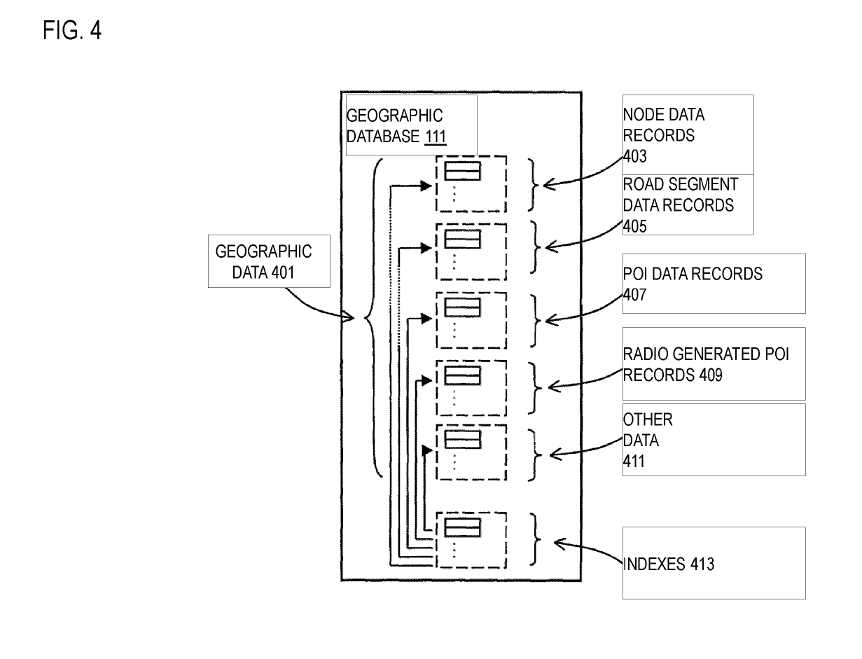

FIG. 4 is a diagram of geographic database 111 of system 100, according to exemplary embodiments. In the exemplary embodiments, POIs and map generated POIs data can be stored, associated with, and/or linked to the geographic database 111 or data thereof. In one embodiment, the geographic or map database 111 includes geographic data 401 used for (or configured to be compiled to be used for) mapping and/or navigation-related services, such as for personalized route determination, according to exemplary embodiments. For example, the geographic database 111 includes node data records 403, road segment or link data records 405, POI data records 407, radio generated POI records 409, and other data records 411, for example. More, fewer or different data records can be provided. In one embodiment, the other data records 411 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records 405 are links or segments representing roads, streets, or paths, as can be used in the calculated route or recorded route information for determination of one or more personalized routes, according to exemplary embodiments. The node data records 403 are end points corresponding to the respective links or segments of the road segment data records 405. The road link data records 405 and the node data records 403 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 407. The geographic database 111 can also include data about places, such as cities, towns, or other communities, and other geographic features, such as bodies of water, mountain ranges, etc. Such place or feature data can be part of the POI data records 407 or can be associated with POIs or POI data records 407 (such as a data point used for displaying or representing a position of a city). In addition, the geographic database 111 can include data from radio advertisements associated with the POI data records 407 and their respective locations in the radio generated POI records 409. By way of example, the POI is determined from the user interaction with the UE 101 and the content information associated with UE 101, according to the various embodiments described herein.

The geographic database 111 can be maintained by the content provider in association with the services platform 113 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., UEs 101) to provided navigation-related functions. For example, the geographic database 111 can be used with the end user device 101 to provide an end user with navigation features. In such a case, the geographic database 111 can be downloaded or stored on the end user device UE 101, such as in applications 103, or the end user device UE 101 can access the geographic database 111 through a wireless or wired connection (such as via a server and/or the communication network 107), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions such as guidance and map display, for example, and for determination of one or more personalized routes or route segments based on one or more calculated and recorded routes, according to exemplary embodiments.

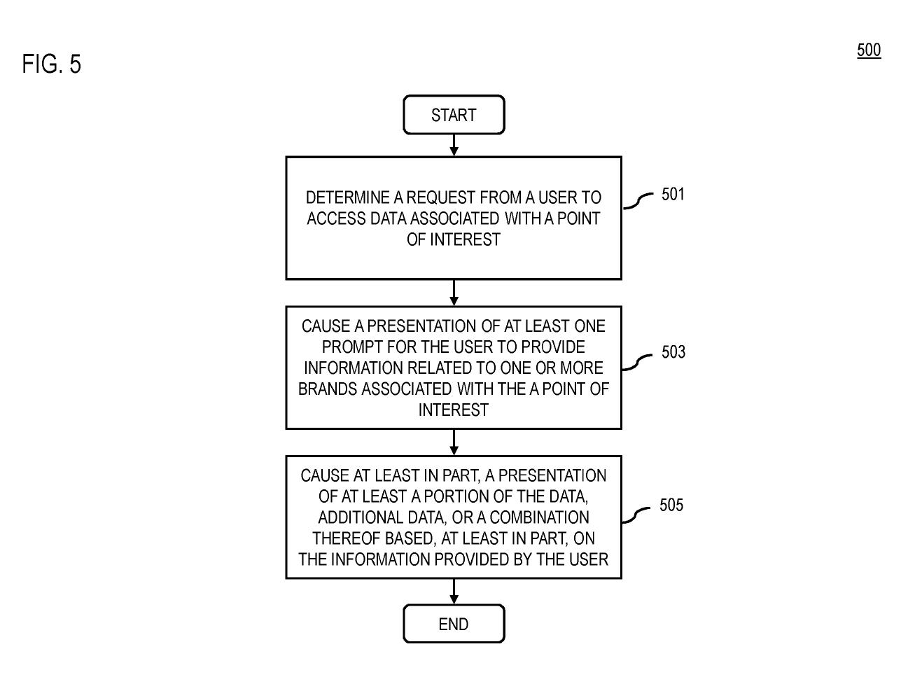

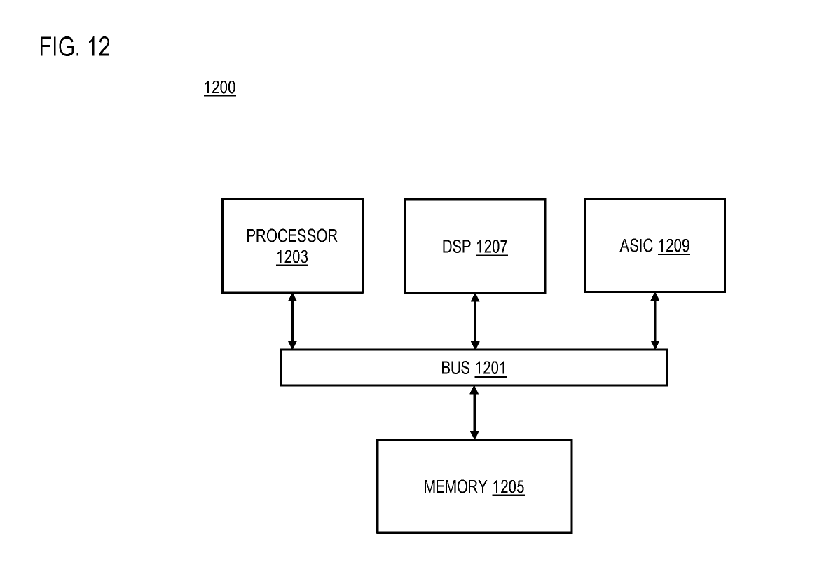

FIG. 5 is a flowchart of a process for causing a presentation of at least a portion of the data, additional data, or a combination thereof for one or more brands associated with the at least one POI based, at least in part, on the information provided by the user, according to one embodiment. In one embodiment, the point of interest platform 109 performs the process 500 and is implemented in, for instance, a chip set including a processor and a memory as shown in FIG. 12.

In step 501, the point of interest platform 109 determines a request from a user to access data associated with at least one point of interest. In one scenario, when a user explores a certain category on map based service, a number of POIs are plotted on the map, however some POIs are protected. A user may request additional information for POIs wherein the point of interest platform 109 may process and/or facilitate a processing of content information associated with POI to determine one or more additional information, queries, or a combination thereof.

In step 503, the point of interest platform 109 causes, at least in part, a presentation of at least one prompt for the user to provide information related to one or more brands associated with the at least one point of interest, wherein the at least one prompt for the user to provide the information related to the one or more brands includes, at least in part, one or more hints. The point of interest platform 109 determines information related to one or more brands for POIs based, at least in part, on popularity information associated with the POIs. The point of interest platform 109 monitors brand information continuously, periodically, according to a schedule, on demand, or a combination thereof; to determine the popular information. The determined popular information may be the reference information. On the other hand, the information provided by the user includes, at least in part, one or more passphrases and/or one or more jingle lyrics and/or one or more audio samples and/or one or more colors and/or one or more shapes and/or one or more images and/or one or more names, associated with the brands of the determined POIs. Then again, a passphrase can be any information provided by a user to unlock the POI.

In step 505, the point of interest platform 109 causes, at least in part, a presentation of at least a portion of the data and/or additional data based, at least in part, on the information provided by the user. The data, the additional data, or a combination thereof include, at least in part, point-of-interest detail information, marketing information, coupon information, discount information, offer information, or a combination thereof. Further, the presentation of the at least a portion of the data, the additional data, or a combination thereof is based, at least in part, one or more contextual parameters including, at least in part, one or more expiration parameters, one or more temporal parameters, one or more location parameters, or a combination thereof. In one embodiment, the point of interest platform 109 processes and/or facilitates the processing the POI information to determine the contextual parameters, causing, at least in part, a validation of the additional information based, at least in part, on a user input received that confirms with the contextual parameters.

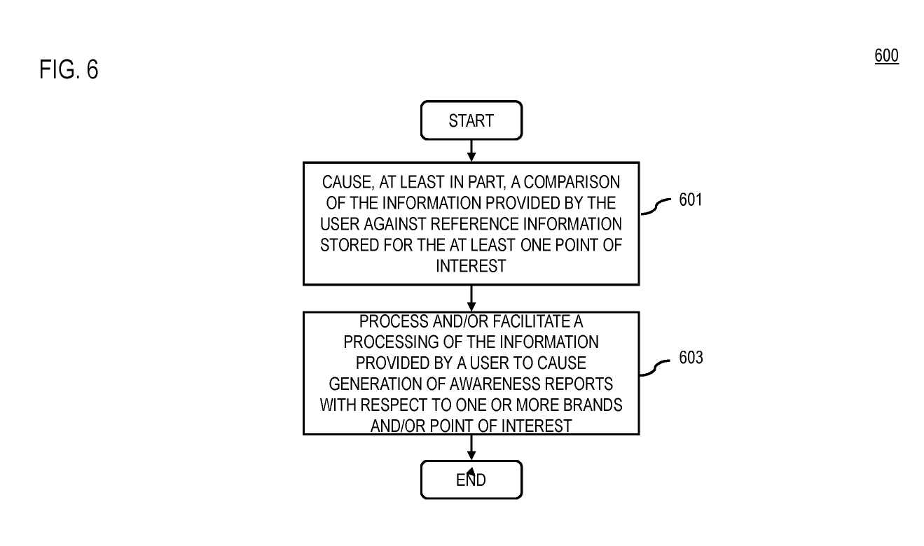

FIG. 6 is a flowchart of a process for causing a processing of the information provided by the user to cause, a generation of one or more awareness reports with respect to the one or more brands, the at least one point of interest, or a combination thereof, according to one embodiment. In one embodiment, the point of interest platform 109 performs the process 600 and is implemented in, for instance, a chip set including a processor and a memory as shown in FIG. 12.

In step 601, the point of interest platform 109 causes, at least in part, a comparison of the information provided by the user against reference information stored for the at least one point of interest, wherein the presentation of the at least a portion of the data, the additional data, or a combination thereof is based, at least in part, on the comparison. The reference information is distributed via one or more social networks, one or more broadcast media, one or more print media, or a combination thereof. In one scenario, a user may be prompted by the point of interest platform 109 to enter a slogan for the brand to access additional information for the brand. Such slogans may be advertised via online social networks, radio campaigns, newspapers, and is easily accessible by the user. In one hand, this process makes the user more aware of the accessed brand information, on the other hand, makes it possible for the brand to monitor user awareness.

In step 603, the point of interest platform 109 processes and/or facilitates a processing of the information provided by the user to cause, at least in part, a generation of one or more awareness reports with respect to the one or more brands, the at least one point of interest, or a combination thereof. In one scenario, if users are not able to answer the queries, based on the awareness report the point of interest platform 109 may suggest a requirement for better marketing tactics for the brand associated with a determined POI.

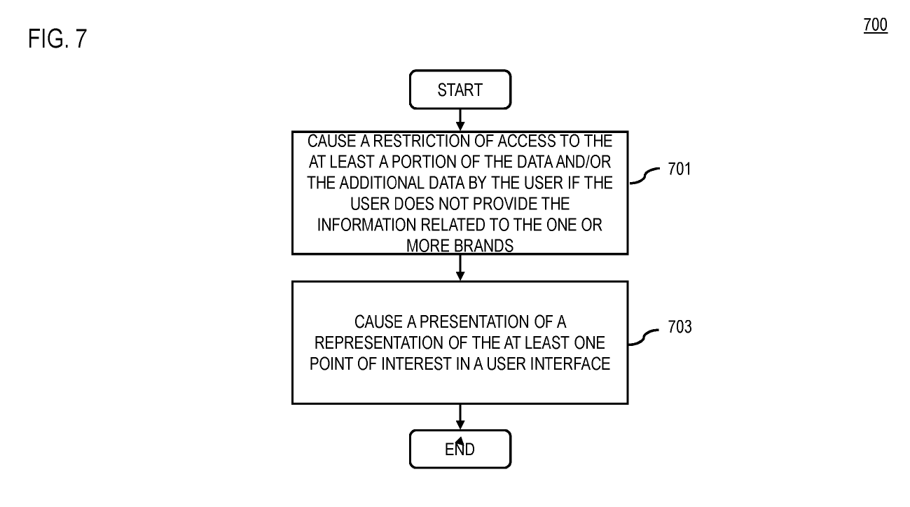

FIG. 7 is a flowchart of a process for causing a presentation of a representation of the at least one point of interest in a user interface if the user provides the information related to the one or more brands, according to one embodiment. In one embodiment, the point of interest platform 109 performs the process 700 and is implemented in, for instance, a chip set including a processor and a memory as shown in FIG. 12.

In step 701, the point of interest platform 109 causes, at least in part, a restriction of access to the at least a portion of the data, the additional data, or a combination thereof by the user if the user does not provide the information related to the one or more brands. In one scenario, a user may have to answer the query prompted before him to access the additional information. The query may require the user to enter words, sentence or a sequence of jingles that is associated with the brand, additional clues on the response to the query could be offered to the user in order to create awareness and help him gain access to the value offerings. However, if the user provides incorrect information, the point of interest platform 109 may prohibit the user from accessing the additional information. Such restriction to information ensures more attentiveness on the part of the users pertaining to the brand information for the respective POIs.

In step 703, the point of interest platform 109 causes, at least in part, a presentation of a representation of the at least one point of interest in a user interface, wherein the representation includes at least one indication that the at least a portion of the data, the additional data, or a combination thereof is available for access if the user provides the information related to the one or more brands. In one scenario, the point of interest platform 109 may present freely accessible POIs alongside query protected POIs, hence giving users an option to choose POIs of their choice. If user chooses to access the query enabled POIs which is easily distinguishable from the freely accessible POIs, the user needs to be aware of the brand information for the POI. It is desirable that the user is aware of the brand information, if not, the user may search for brand information in social networks, broadcast medias, print medias, hence igniting a sense of inquisitiveness amongst the users for the brand.

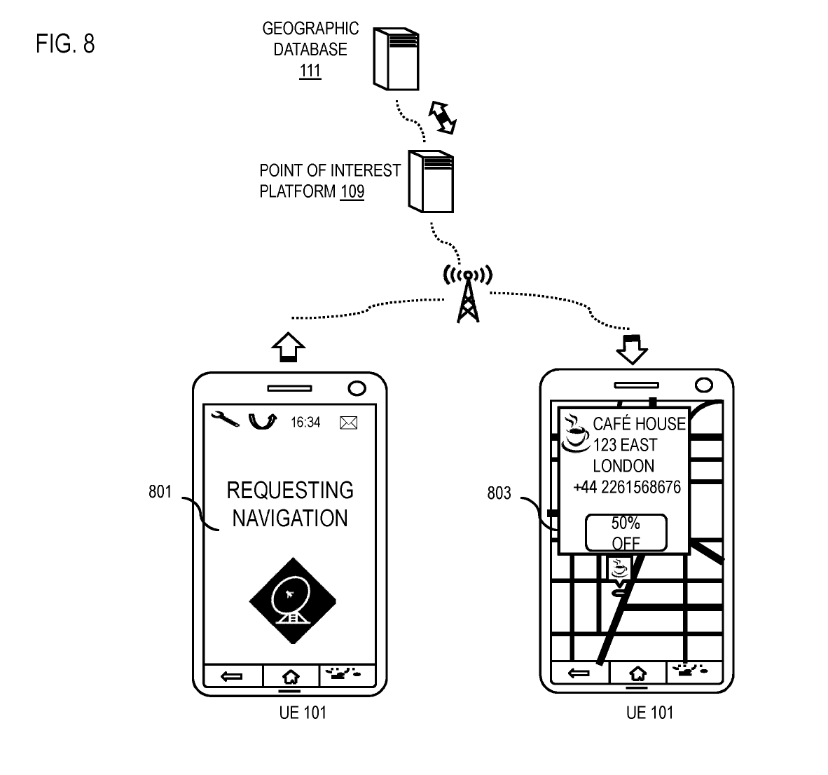

FIG. 8 is a diagram of user interfaces utilized in the processes of FIGS. 5-7, according to various embodiments. For example, FIG. 8 illustrates a method for causing presentation of at least a portion of the data, additional data, or a combination thereof for one or more brands associated with the at least one POI based, at least in part, on the information provided by the user. In one scenario, whenever a user needs to go to several destinations, the user may use his mobile phone (e.g., UE 101a with user interface 801) to use the navigation services while driving to those destinations. The idea is that those destinations have some kind of content information (e.g., location information, contact information, brand names or logos) to it. The UE 101a generates a request for presentation of data and/or additional data for one or more brands associated with the at least one POI and sends the request to the point of interest platform 109. The point of interest platform 109 retrieves the contextual information of the UE 101a from the applications 103, the sensors 105, the geographic database 111, services 115, content provider 117, and processes the contextual information. In one embodiment, the point of interest platform 109 crawls through various systems of the communication network 107 and may gain access to the content information related to the POI. The brand attributes for determined POIs are then extracted, and displayed with the POIs. The interface 803 of UE 101 displays the presentation of the one or more brand as visual representation for POI.

As shown in FIG. 8, the user's device downloads POI, café house. The determined POI may possess the following information:
(a) POI Name: café house
Address: ABC street,
GHI colony—560037
   The point of interest platform 109 may present the determined POI with its brand logo and may query protect the POIs (user interface 803), such POIs may have location and/or information guarantee, and are validated POIs and the user can be sure of the authenticity of the information. The user may open the POI and access basic information which is freely available, however, the user must answer the query to access information which the user otherwise would have no access to, such as, 50% discount on ground coffee. Therefore, the user may access brand information via navigation services, enhancing the user experience of the navigation application. In one scenario, while trying to access additional information a user may be asked to whistle POI related jingle, the actual tune rather than just the words or lyrics, as a way to get more information about POI.

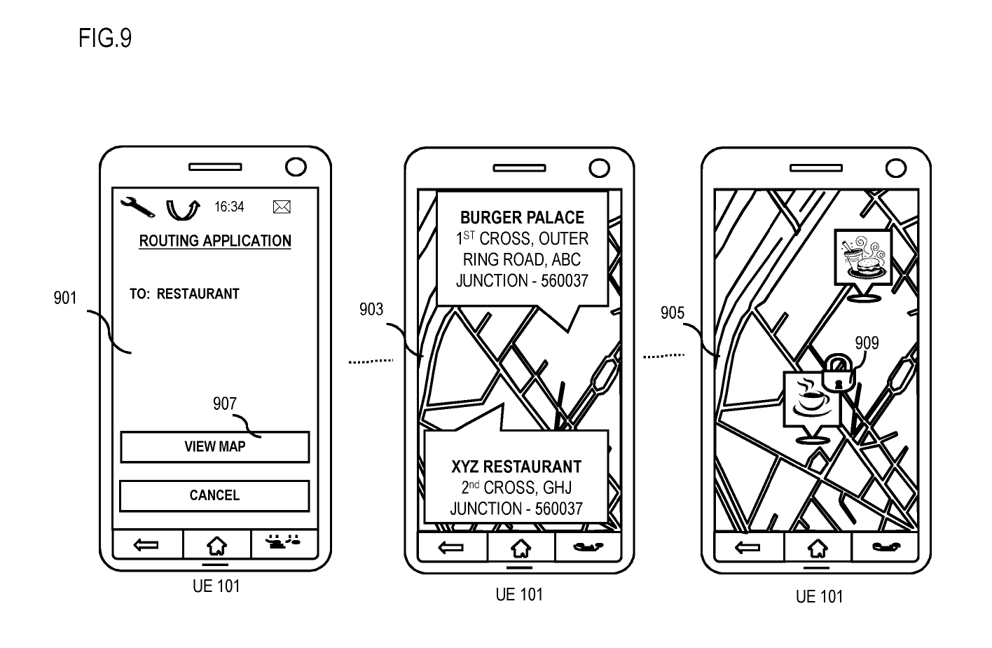

FIG. 9 is a diagram of user interfaces utilized in the processes of FIGS. 5-7, according to various embodiments. As shown in user interface 901, the point of interest platform 109 performs a lookup for brands associated with the specific POIs (I.e. restaurants). The user may enter their search criteria and then select action button 907 to begin the search process. Also, based on the sensor information for indicating their present location along with the attributes associated with the UE 101, the user is presented with an option to include restaurants which match the contextual profile of UE 101. Resultantly, the point of interest platform 109 causes the user interface of UE 101 to be updated to reference the brands alongside the POIs.

The user interface 903 depicts a typical presentation of POI information in a navigation application wherein all the information for POI is displayed. However, the point of interest platform 109 causes a presentation of user interface 905 wherein the user is presented with details regarding the route as well as details regarding the brands for POIs upon which the route is based. Such presentation of a representation of POI in a user interface includes an indication that additional data is available for access if the user answers the query by providing the information related to the one or more brands. In one scenario, location based services are free to download and use, by default, multiple POIs may be freely accessible while the premium ones are highlighted visually (e.g. icon 909) and provides a way for the user to get a lot more value out of the POI data by providing answers for the queries. In another embodiment, the users may pay a small fee to the location service providers to access value offers. The fee may be levied per POIs as well, and the user may have to pay small amount to unlock POIs.

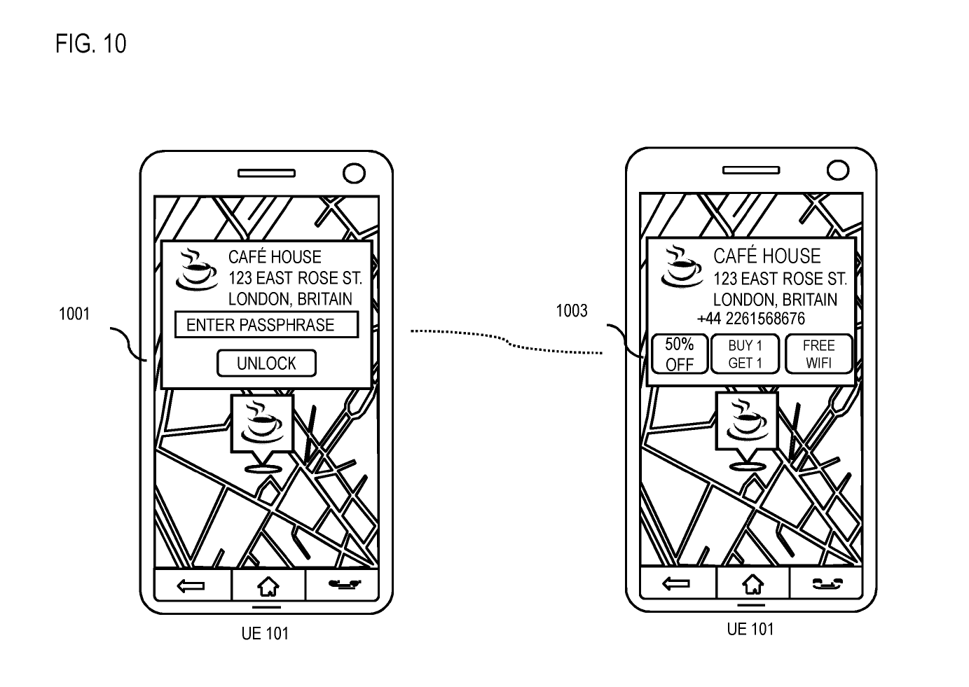

FIG. 10 is a diagram of user interfaces utilized in the processes of FIGS. 5-7, according to various embodiments. As illustrated, user interface 1001 depicts a presentation of a prompt to the user who wants to access data associated with POI, to provide information related to one or more brands associated with the POI. Such prompt for the user may include one or more hints. In one scenario, the user may be asked about the color or shape of the brand for POI whilst the brand is being displayed next to the query. Whereas, the user interface 1003 depicts a process wherein the point of interest platform 109 compares the information provided by the user against the reference information stored for the POI. The point of interest platform 109 makes a presentation of the privileged information based on the comparison. As displayed, the user may get additional information, such as, 50% off on all purchases and/or buy one, get one and/or free WiFi. The additional information are further based, at least in part, one or more contextual parameters including, at least in part, one or more expiration parameters and/or one or more temporal parameters and/or one or more location parameters. In one scenario, a user may be given access to the additional information, the validity of which may be three days from the date of access and the user have to act within the time frame. Similarly, a user may be given value offers which may be used for POI in a specific location. On the other hand, the point of interest platform 109 may deny access to the privileged information if the user provides wrong input to the query.

The processes described herein for providing passphrase enabled POIs, by causing a presentation of at least a portion of the data, additional data, or a combination thereof for one or more brands associated with the at least one POI based, at least in part, on the information provided by the user may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

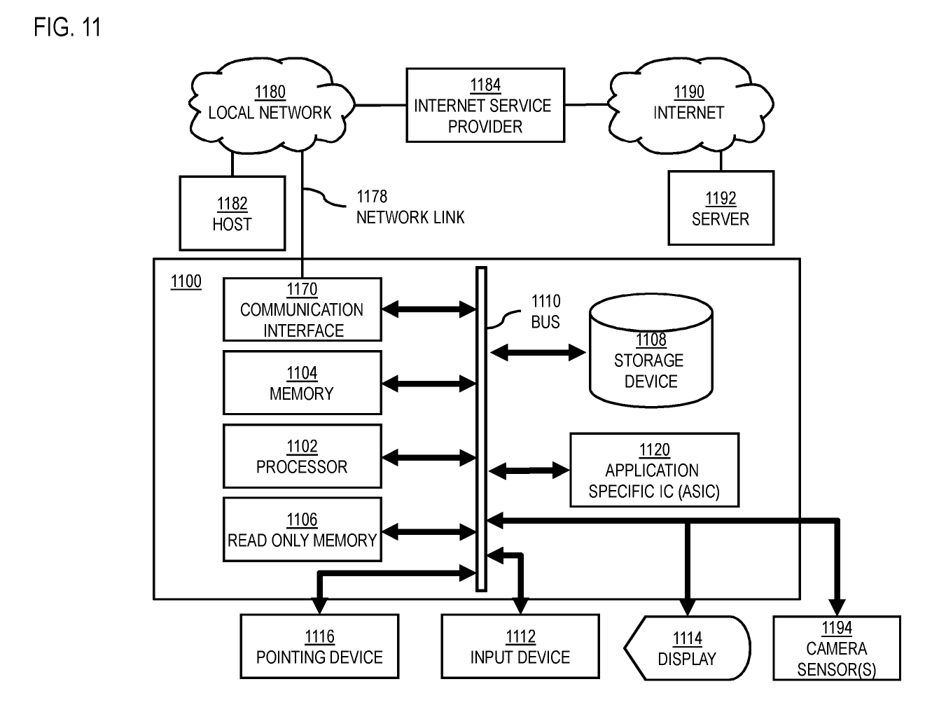

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to cause brand awareness, by causing a presentation of at least a portion of the data, additional data, or a combination thereof for one or more brands associated with the at least one POI based, at least in part, on the information provided by the user as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of providing passphrase enabled POIs, by causing a presentation of at least a portion of the data, additional data, or a combination thereof for one or more brands associated with the at least one POI based, at least in part, on the information provided by the user.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to providing passphrase enabled POIs, by causing a presentation of at least a portion of the data, additional data, or a combination thereof for one or more brands associated with the at least one POI based, at least in part, on the information provided by the user. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1100 also includes a memory 1104 coupled to bus 1110. The memory 1104, such as a random access memory (RAM) or any other dynamic storage device, stores information including processor instructions for providing passphrase enabled POIs, by causing a presentation of at least a portion of the data, additional data, or a combination thereof for one or more brands associated with the at least one POI based, at least in part, on the information provided by the user. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing passphrase enabled POIs, by causing a presentation of at least a portion of the data, additional data, or a combination thereof for one or more brands associated with the at least one POI based, at least in part, on the information provided by the user, is provided to the bus 1110 for use by the processor from an external input device 1112, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114, and one or more camera sensors 1194 for capturing, recording and causing to store one or more still and/or moving images (e.g., videos, movies, etc.) which also may comprise audio recordings. In some embodiments, for example, in embodiments in which the computer system 1100 performs all functions automatically without human input, one or more of external input device 1112, display device 1114 and pointing device 1116 may be omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for providing passphrase enabled POIs, by causing a presentation of at least a portion of the data, additional data, or a combination thereof for one or more brands associated with the at least one POI based, at least in part, on the information provided by the user to the UE 101.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to cause brand awareness, by causing a presentation of at least a portion of the data, additional data, or a combination thereof for one or more brands associated with the at least one POI based, at least in part, on the information provided by the user as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of providing passphrase enabled POIs, by causing a presentation of at least a portion of the data, additional data, or a combination thereof for one or more brands associated with the at least one POI based, at least in part, on the information provided by the user.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to cause brand awareness, by causing a presentation of at least a portion of the data, additional data, or a combination thereof for one or more brands associated with the at least one POI based, at least in part, on the information provided by the user. The memory 1205 also stores the data associated with or generated by the execution of the inventive steps.

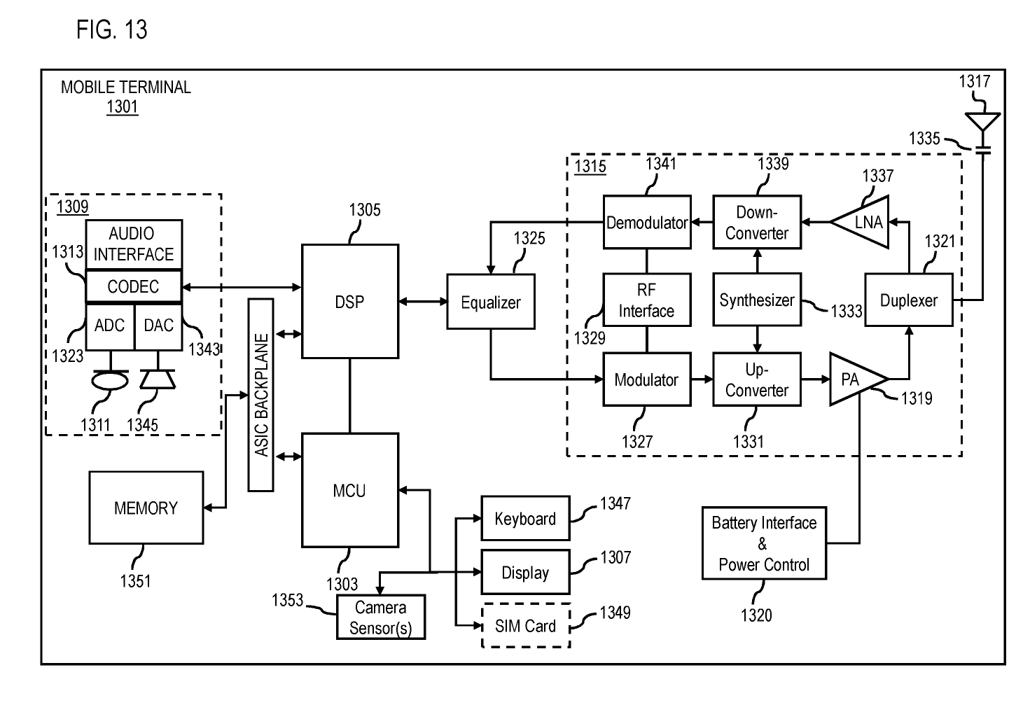

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of providing passphrase enabled POIs, by causing a presentation of at least a portion of the data, additional data, or a combination thereof for one or more brands associated with the at least one POI based, at least in part, on the information provided by the user. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of providing passphrase enabled POIs, by causing a presentation of at least a portion of the data, additional data, or a combination thereof for one or more brands associated with the at least one POI based, at least in part, on the information provided by the user.

The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to cause brand awareness, by causing a presentation of at least a portion of the data, additional data, or a combination thereof for one or more brands associated with the at least one POI based, at least in part, on the information provided by the user.

The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

Further, one or more camera sensors 1353 may be incorporated onto the mobile station 1301 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-48. (canceled)

49. A method comprising:
at least one determination of a request from a user to access data associated with at least one point of interest;
a presentation of at least one prompt for the user to provide information related to one or more brands associated with the at least one point of interest; and
a presentation of at least a portion of the data, additional data, or a combination thereof based, at least in part, on the information provided by the user.

50. The method of claim 49, further comprising:
a comparison of the information provided by the user against reference information stored for the at least one point of interest,
wherein the presentation of the at least a portion of the data, the additional data, or a combination thereof is based, at least in part, on the comparison.

51. The method of claim 50, wherein the reference information is distributed via one or more social networks, one or more broadcast media, one or more print media, or a combination thereof.

52. The method of claim 49, wherein the at least one prompt for the user to provide the information related to the one or more brands includes, at least in part, one or more hints.

53. The method of claim 49, further comprising:
a processing of the information provided by the user to cause, at least in part, a generation of one or more awareness reports with respect to the one or more brands, the at least one point of interest, or a combination thereof.

54. The method of claim 49, wherein the presentation of the at least a portion of the data, the additional data, or a combination thereof is based, at least in part, on one or more contextual parameters including, at least in part, one or more expiration parameters, one or more temporal parameters, one or more location parameters, or a combination thereof.

55. The method of claim 49, further comprising:
a restriction of access to the at least a portion of the data, the additional data, or a combination thereof by the user if the user does not provide the information related to the one or more brands.

56. The method of claim 49, further comprising:
a presentation of a representation of the at least one point of interest in a user interface,
wherein the representation includes at least one indication that the at least a portion of the data, the additional data, or a combination thereof is available for access if the user provides the information related to the one or more brands.

57. The method of claim 49, wherein the information provided by the user includes, at least in part, one or more passphrases, one or more jingle lyrics, one or more audio samples, one or more colors, one or more shapes, one or more images, one or more names or a combination thereof.

58. The method of claim 49, wherein the data, the additional data, or a combination thereof include, at least in part, point-of-interest detail information, marketing information, coupon information, discount information, offer information, or a combination thereof.

59. An apparatus comprising:
at least one processor; and
at least one memory including computer program code for one or more programs,
the at least one memory and the computer program code configured to, with the at least one processor, cause the apparatus to perform at least the following,
determine a request from a user to access data associated with at least one point of interest;
cause, at least in part, a presentation of at least one prompt for the user to provide information related to one or more brands associated with the at least one point of interest; and
cause, at least in part, a presentation of at least a portion of the data, additional data, or a combination thereof based, at least in part, on the information provided by the user.

60. The apparatus of claim 59, wherein the apparatus is further caused to:
cause, at least in part, a comparison of the information provided by the user against reference information stored for the at least one point of interest,
wherein the presentation of the at least a portion of the data, the additional data, or a combination thereof is based, at least in part, on the comparison.

61. The apparatus of claim 60, wherein the reference information is distributed via one or more social networks, one or more broadcast media, one or more print media, or a combination thereof.

62. The apparatus of claim 59, wherein the at least one prompt for the user to provide the information related to the one or more brands includes, at least in part, one or more hints.

63. The apparatus of claim 59, wherein the apparatus is further caused to:
process and/or facilitate a processing of the information provided by the user to cause, at least in part, a generation of one or more awareness reports with respect to the one or more brands, the at least one point of interest, or a combination thereof.

64. The apparatus of claim 59, wherein the presentation of the at least a portion of the data, the additional data, or a combination thereof is based, at least in part, on one or more contextual parameters including, at least in part, one or more expiration parameters, one or more temporal parameters, one or more location parameters, or a combination thereof.

65. The apparatus of claim 59, wherein the apparatus is further caused to:
cause, at least in part, a restriction of access to the at least a portion of the data, the additional data, or a combination thereof by the user if the user does not provide the information related to the one or more brands.

66. The apparatus of claim 59, wherein the apparatus is further caused to:
cause, at least in part, a presentation of a representation of the at least one point of interest in a user interface,
wherein the representation includes at least one indication that the at least a portion of the data, the additional data, or a combination thereof is available for access if the user provides the information related to the one or more brands.

67. The apparatus of claim 59, wherein the information provided by the user includes, at least in part, one or more passphrases, one or more jingle lyrics, one or more audio samples, one or more colors, one or more shapes, one or more images, one or more names or a combination thereof.

68. The apparatus of claim 59, wherein the data, the additional data, or a combination thereof include, at least in part, point-of-interest detail information, marketing information, coupon information, discount information, offer information, or a combination thereof.
